(19) United States
(12) Patent Application Publication
(10) Pub. No.: US 2011/0299726 A1
(43) Pub. Date: Dec. 8, 2011

(54) METHOD AND APPARATUS FOR INSPECTING WHETHER A SURFACE OF AN ARTICLE IS PROVIDED WITH A VALUABLE DOCUMENT

(75) Inventor: HAUKE LÜBBEN, RADOLFZELL (DE)

(73) Assignee: SIEMENS AKTIENGESELLSCHAFT, MUENCHEN (DE)

(21) Appl. No.: 13/151,434

(22) Filed: Jun. 2, 2011

(30) Foreign Application Priority Data
Jun. 2, 2010 (DE) 10 2010 022 532.0

(51) Int. Cl. G06K 9/00

(52) U.S. Cl. 382/101

(57) ABSTRACT

A method and an apparatus inspect whether a surface of an article has a valuable document, in particular whether a piece of mail is provided with a franking mark. A computer-available image of the surface region to be examined is generated. An inspection determines whether the image contains an object image which corresponds to an object image stored in a valuable document data memory. When the image contains a corresponding object image, it is determined that the surface region has a valuable document. When the image does not contain such an object image, then an inspection is carried out to determine if a predefined inspection region has a predefined security feature. When a security feature has been determined, a valuable document is sought in the inspection region using the image. When a valuable document is found in the inspection region, an image of the valuable document is generated and stored.

### CROSS-REFERENCE TO RELATED APPLICATION

This application claims the priority, under 35 U.S.C. §119, of German application DE 10 2010 022 532.0, filed Jun. 2, 2010; the prior application is herewith incorporated by reference in its entirety.

### BACKGROUND OF THE INVENTION

### Field of the Invention

The invention relate to a method and an apparatus for inspecting whether a surface of an article is provided with a valuable document, in particular whether a surface of a flat item of mail is provided with a franking mark.

For example when sorting and processing flat items of mail, it is desired to ascertain in a timely manner whether or not an item of mail to be sorted is provided with a valid stamp or some other valid franking mark. The way in which the franking mark to be examined is oriented on the item of mail with respect to a sensor is generally not known beforehand.

Published, non-prosecuted German patent application DE 10105273 A1, corresponding to U.S. Pat. No. 7,529,386, describes a method and an apparatus for checking a frank on an item of mail. A sensor S of a symbol recognition unit ACR detects a graphical symbol on the item of mail, e.g. a stamp. A data processing unit compares the detected graphical information with representations of franks that are stored in a database. A learning system learns symbols for the database. The learned symbols are graphical reproductions of valid stamps. A stamp recognition unit BME checks whether a frank has a fluorescent region. A superfluorescence sensor SFL-S checks whether or not a frank has a security feature. If the sensor S has detected a symbol on the item of mail which is not stored in the database, then the superfluorescence sensor SFL-S checks whether the frank on the item of mail nevertheless has a second security feature. If this is the case, then the item of mail is treated as a valid item of mail and conveyed further. Otherwise, the item of mail is ejected.

In published, European patent application EP 1909234 A1, corresponding to U.S. Pat. No. 7,529,386, detected graphical information on an item of mail is likewise compared with symbols stored in a database with valid symbols. A learning system learns symbols for the database. If a detected symbol on an item of mail does not correspond to a stored symbol, then a superfluorescence sensor SFL-S checks whether a second security feature is present on the item of mail. If the second security feature is present, then the item of mail is recognized as a valid item of mail and conveyed further.

Published, non-prosecuted German patent application DE 10106632 A1, corresponding to U.S. Pat. No. 7,646,885, describes a method and an apparatus for checking a franking mark applied to an item of mail. A stamp recognition unit BME irradiates the surface of the item of mail with light, and a fluorescence sensor of the stamp recognition unit detects a region on the item of mail which is provided with a fluorescent agent and is excited by the irradiation. A valid stamp often contains such a fluorescent agent. Downstream of the stamp recognition unit BME is situated a checking device SFL-S, which checks a security feature. The checking device SFL-S can be designed as a superfluorescence sensor. Further downstream, a symbol recognition unit determines graphical symbols on the item of mail. Such a graphical symbol can be e.g. a valid stamp. The symbol recognition unit has a sensor that detects a symbol on the item of mail. A data processing system compares a detected graphical symbol or some other information with stored representations of franks. A turning path or some other transport path can be situated upstream of the symbol recognition unit ACR. The data processing unit accesses a database with symbols stored therein. A learning system learns symbols for the database. In the course of operation, first the stamp recognition unit BME checks whether a frank is present on the item of mail. Said frank should carry a security feature. The downstream checking device checks whether the frank actually carries such a security feature. A valid frank without superfluorescence can be identified by the symbol recognition unit checking the presence of a corresponding graphical symbol.

### SUMMARY OF THE INVENTION

It is accordingly an object of the invention to provide a method and an apparatus for inspecting whether a surface of an article is provided with a valuable document which overcome the above-mentioned disadvantages of the prior art methods and devices of this general type, in which the inventive device and method are performed without a complete data memory with images of all the valuable documents used needing to be predefined.

The apparatus according to the solution contains an image recording device, an image evaluation unit, at least one security feature detector, preferably a plurality of security feature detectors, a valuable document data memory, and a security feature data memory.

Computer-available identifications of predefined security features are stored in the security feature data memory. Computer-available images of valuable documents can be stored in the valuable document data memory, and, in one configuration, some images of valuable documents are already stored therein.

According to the solution, an inspection is carried out to determine whether or not a region of a surface of an article is provided with a valuable document. Each genuine valuable document is provided with a predefined security feature, the identification of which is stored in the security feature data memory. It is possible, however, that forged valuable documents are used or that a region of an article is provided with an object which is similar to a valuable document, without being a valuable document.

According to the solution, the now described steps are carried out.

The image recording device generates a computer-available image of that region of the surface of the article which is intended to be examined.

The image evaluation unit inspects whether the image contains an object image of an object, wherein the object shown has the following property: the object image of the object corresponds to a computer-available image of a valuable document which is already stored in the valuable document data memory. The valuable document data memory is searched for this inspection.

If a stored image corresponding to the object image in the image is found in the valuable document data memory, then it is decided that the object is a valuable document and the region is provided with the valuable document. The fact of whether the valuable document is genuine, in general, cannot yet be unambiguously determined by this inspection by means of the valuable document data memory.

At least when no corresponding image is found in the valuable document data memory, the now described steps are implemented.

The security feature detector inspects whether or not a predefined inspection region has a predefined security feature. For this purpose, the security feature detector evaluates the security feature data memory. The examined inspection region lies in the surface region to be examined. The inspection region can be smaller than the surface region, such that although a genuine valuable document with security features is situated in the object region, it is situated outside the inspection region.

When the security feature detector has discovered such a predefined security feature, the image evaluation unit searches for a valuable document in the inspection region. For this purpose, the image evaluation unit evaluates the image of the surface region of the article and searches for an image of a valuable document in the image. This examined image shows the complete inspection region.

When the image evaluation unit has found a valuable document in the inspection region, the image evaluation unit generates an image of this valuable document found. For this purpose, the image evaluation unit uses the image of the surface region. This generated image is stored in the valuable document data memory.

It is decided that the surface of the article in the inspection region is provided with a valuable document.

The invention obviates the need to produce beforehand a valuable document data memory containing images of all the valuable documents used. Producing the data memory costs time. Moreover, the invention obviates the need to constantly update the valuable document data memory manually. Before the checking process, the valuable document data memory of the apparatus according to the solution can be empty, i.e. contain as yet no images of valuable documents at all, or already contain some images. In no way is it necessary for the valuable document data memory to contain beforehand a respective image of every possible valuable document. Rather, the valuable document data memory is filled while the method according to the solution is implemented. Although a complete valuable document data memory need not be predefined before the beginning of the implementation of this method, a reliable inspection is possible.

The method according to the solution and the apparatus according to the solution yield a positive result, namely the result that the surface is provided with a valuable document, only when a genuine valuable document is present in an inspection region of a security feature detector. Only images of genuine valuable documents are accommodated in the valuable document data memory.

The invention makes it possible to configure the checking of an article as required and, in the process, to utilize the advantage that a complete valuable document data memory need not necessarily be present. In particular, the now described configurations can be realized.

An inspection is carried out to determine whether an article is provided with a genuine valuable document. This is the case only when the article is provided with a valuable document which corresponds to a valuable document stored in the valuable document data memory, and the valuable document also has a security feature which is recognized.

An inspection is carried out to determine whether the article is provided with a valuable document which corresponds to a stored valuable document, and whether the article has a security feature. A separate inspection is not carried out to determine whether the valuable document has this security feature.

An inspection is carried out to determine whether the article is provided with a valuable document which corresponds to a stored valuable document. No inspection is carried out to determine whether the article has a security feature. Therefore, an inspection to determine whether the valuable document is a genuine valuable document is not carried out either.

An inspection is carried out to determine whether a predefined criterion is satisfied, and, when the predefined criterion is satisfied, the corresponding object image which is stored in a further data memory is stored in the valuable document data memory.

An inspection is carried out to determine whether the article is provided with a valuable document which corresponds to a stored valuable document. If a corresponding valuable document is found, then a property of the valuable document or a property of the article is determined. The property of the valuable document is e.g. an indication of value. The property of the article is e.g. a dimensioning or the weight of the article. If this property determined satisfies a predefined criterion, if e.g. the indication of value is greater than a predefined lower limit, then an additional check is carried out to determine whether the article is provided with a security feature. The inspection to determine whether a security feature is present is carried out even when the valuable document on the article does not correspond to a stored valuable document.

By contrast, methods known from citations mentioned above can use an image of the valuable document only for the inspection to determine whether or not the image of the valuable document corresponds to a stored valuable document image. If no corresponding stored image is found, then all that remains is to restrict the inspection to the examination of security features, without taking account of a valuable document image on the article.

It is possible, but not necessary, for a processor to check whether an image shows a genuine valuable document, before said image is accommodated in the valuable document data memory. Even without such manual checking, a valuable document data memory with images of genuine valuable documents is produced automatically.

The inspection according to the solution does not necessarily yield a reliable statement about whether the surface is provided with a genuine valuable document, but rather a statement about whether the surface is provided with a valuable document at all. However, the inspection according to the solution makes it possible subsequently to evaluate an image of the valuable document found, e.g. in order to determine the value of the valuable document. Furthermore, it becomes possible to process, e.g. to rotate and to turn, the article depending on the result of the inspection, in order to cancel the valuable document or to process the article in some other way. These processing steps do not necessarily already require the result of the inspection as to whether the valuable document is genuine.

Published, non-prosecuted German patent application DE 10 2007 058 680 A1 describes a valuable document with a security element. The security element is a two-dimensional structure applied to the valuable document, wherein two different substances are applied to the valuable document. The two substances have the same hue upon irradiation in visible light, whereas they have different hues upon irradiation with infrared light.

In one configuration, an image of a valuable document is stored in the valuable document data memory already upon the first occurrence on an article, if the article has a security feature. In another configuration, a candidate data memory is used. The first occurrence of a valuable document on an article initiates, when the valuable document is not stored in the valuable document data memory and the security feature is discovered on the article, the step of storing an image of the valuable document in the candidate data memory. The image stored in the candidate data memory is then transferred into the valuable document data memory and stored in the valuable document data memory, if a predefined criterion is satisfied. By way of example, this involves counting how often a valuable document, an image of which is stored in the candidate data memory, occurs on an article. If this number of occurrence reaches and exceeds a predefined limit, then the predefined criterion is satisfied. In one configuration, the predefined criterion is satisfied when a confirmation signal for the image arrives. The confirmation signal originates from an external inspection, e.g. a manual inspection of images in the candidate data memory.

The invention can be used e.g. for valuable documents in the form of franking marks on items of mail, for conveyance marks and seals and the like on items of baggage or items of freight, for fee stamps on official paper-based documents or else for the recognition of banknotes e.g. of different currencies.

Other features which are considered as characteristic for the invention are set forth in the appended claims.

Although the invention is illustrated and described herein as embodied in a method and an apparatus for inspecting whether a surface of an article is provided with a valuable document, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing the flow of items of mail through an apparatus according to the solution according to the invention;

FIG. 2 is an illustration showing further data flows which arise in the case of the material flow from FIG. 1;

FIG. 3 is an illustration showing an item of mail and an inspection region of a security feature detector; and

FIG. 4 is an illustration showing the item of mail from FIG. 3 after an orientation change.

### DETAILED DESCRIPTION OF THE INVENTION

In the exemplary embodiment, the invention is applied to flat items of mail that are provided with a respective franking mark (“indicia”). The franking mark can have the form of a stamp, a postmark, a barcode or a matrix code.

The invention is used in the exemplary embodiment with the now described aims. First, the intention is to recognize at an early stage during processing where on the item of mail a franking mark is applied, or that the item of mail has no franking mark.

Second, the intention is to recognize at an early stage whether the franking mark is genuine and valid and, if so, what value the franking mark has. An item of mail without a franking mark or with a franking mark not recognized as genuine is intended to be ejected at an early stage. A franking mark is genuine if the franking mark has a predefined valid security feature and is a valid franking mark. A franking mark is valid when the respective carrier accepts this type of franking mark as proof of payment for an item of mail. It is possible for an item of mail to have a valid, but counterfeit, franking mark. One example of a genuine, but invalid, franking mark is a genuine stamp from another transport service provider that likewise carries a valid security feature.

Third, in one configuration, the intention is to cancel the franking mark, in particular a stamp. The cancellation is carried out by a cancelling imprint being imprinted on the item of mail and over the franking mark. This requires the item of mail to be oriented relative to a print head in such a way that the print head reaches the franking mark. Enough time is intended to be available in order that the imprint can dry and does not smear.

Fourth, in one configuration, the intention is moreover to decide whether further parameters of the item of mail are measured in order, depending on these further parameters, to decide whether or not the franking mark proves a sufficient conveyance payment for the item of mail. Further parameters are e.g. the weight or dimensioning of the item of mail. This requires recognition of the value of the franking mark.

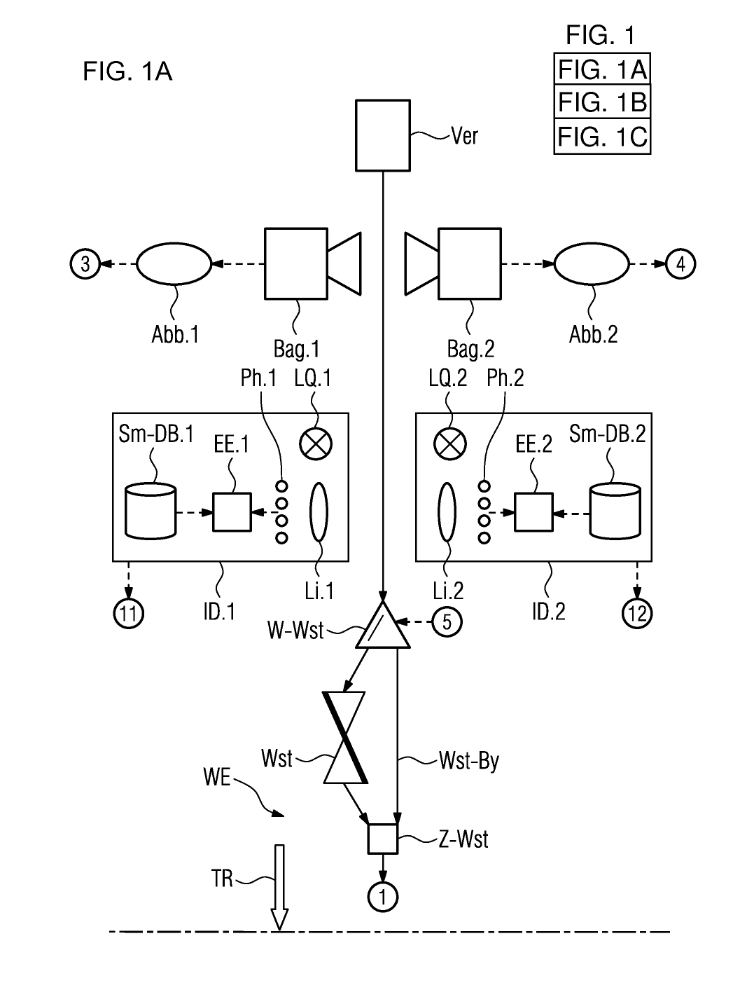

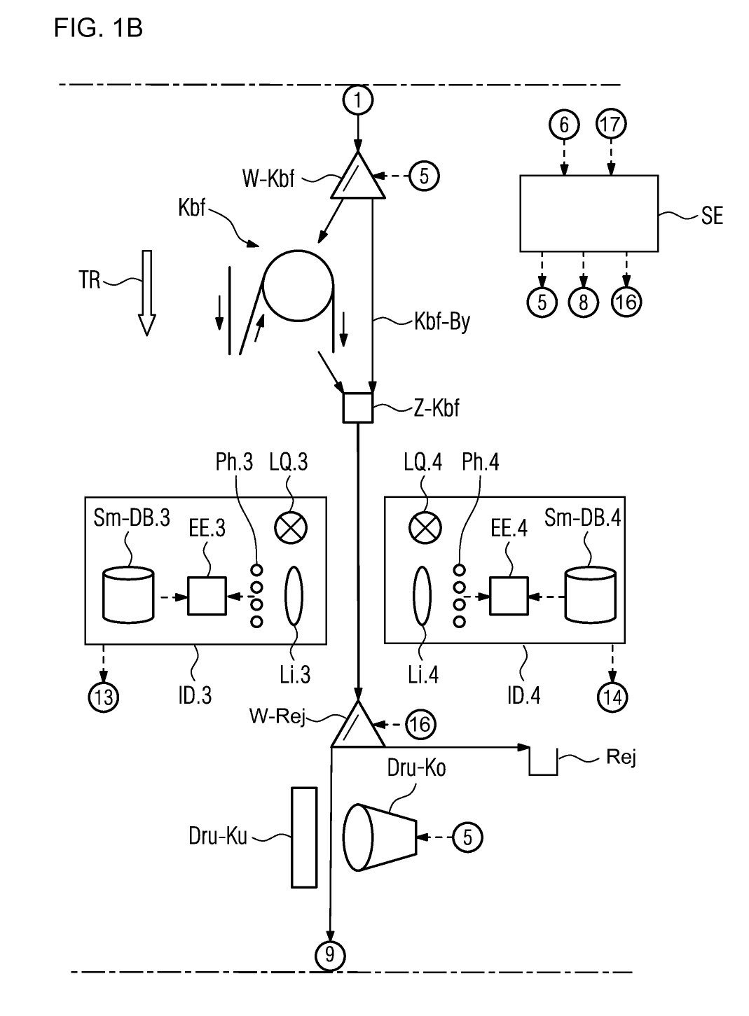

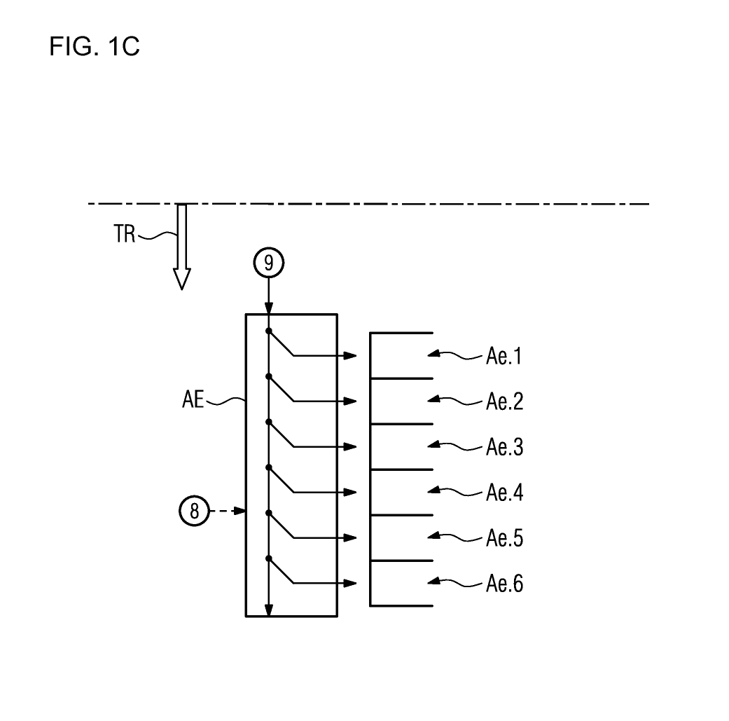

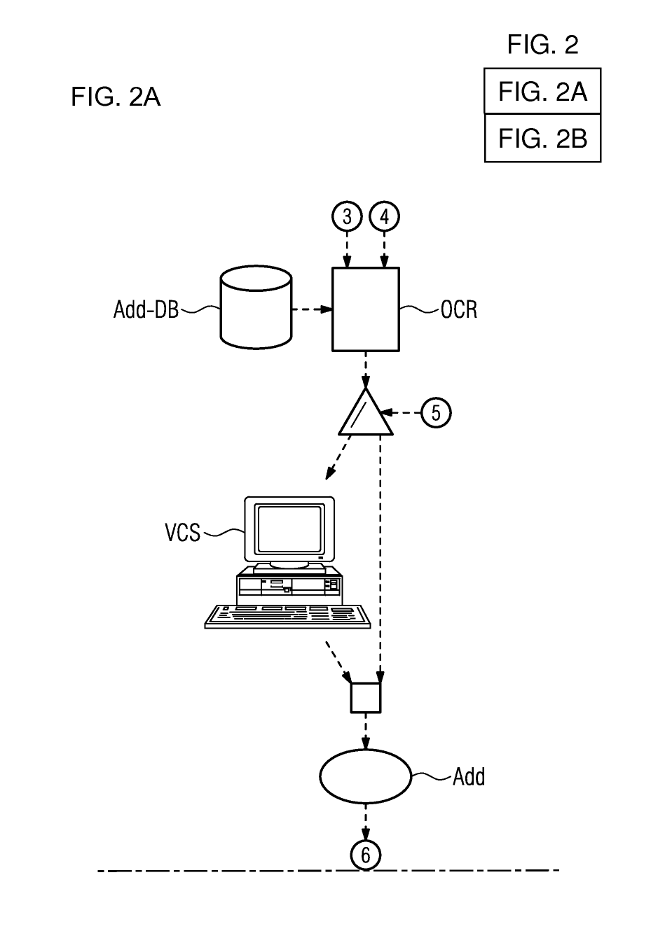

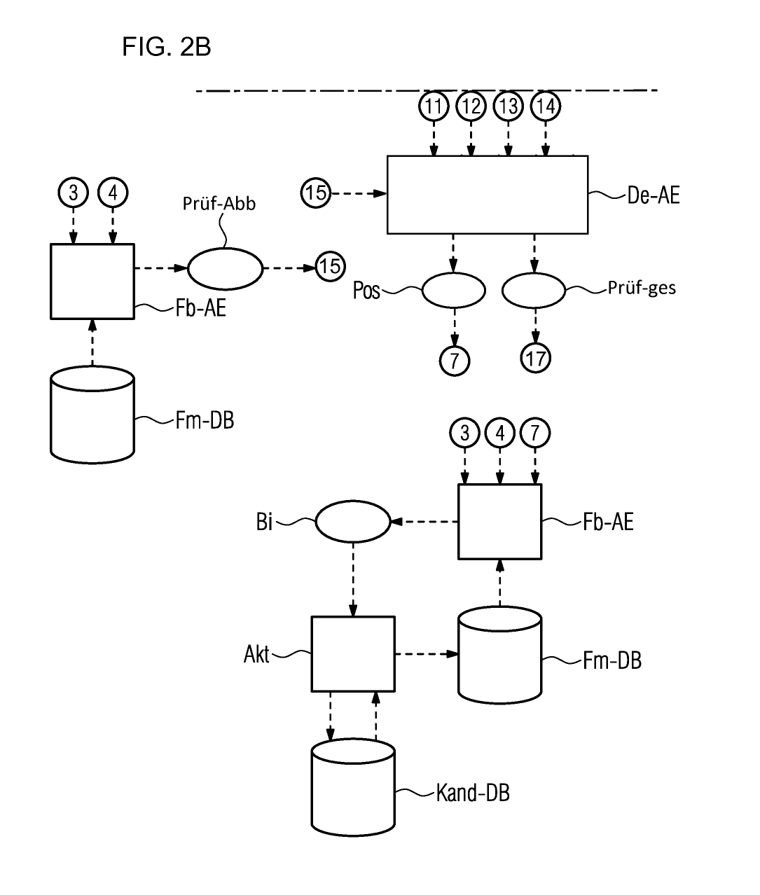

FIG. 1 shows the flow of items of mail through the apparatus according to the solution. FIG. 2 shows further data flows in the case of the material flow of the item of mail through the apparatus from FIG. 1. Material flows are represented by solid arrows, and data flows by dashed arrows, in the figures.

In the exemplary embodiment, a sorting installation is used. The sorting installation has at least the following components: a singulator Ver, a first transport device and a second transport device, an ejecting device AE with a multiplicity of sorting end points Ae.1, Ae.2, . . . , two color image cameras Bag.1, Bag.2, a color image evaluation unit Fb-AE, one, two or else four security feature detectors (“indicia detectors”) ID.1, ID.2, . . . , a detector evaluation unit De-AE, a turning device WE with a turning path Wst, a franking mark database Fm-DB with an updating unit Akt, a printer Dru with a print head Dru-Ko and a printing gate Dru-Ku and a control unit SE.

In one configuration, the sorting installation additionally has at least one of the following components: an address reader OCR-VCS with an OCR unit OCR, a video coding station VCS and an address database Add-DB, or a rotating device DE with a head station Kbf.

The singulator Ver produces a stream of upright items of mail that are spaced apart from one another. These items of mail leave the singulator Ver as a stream of articles.

The optional address reader OCR-VCS can decipher indications regarding a destination address. These indications are applied on the item of mail. The address reader OCR-VCS, for deciphering purposes, evaluates an image of the surface of the items of mail with the destination address indications. In one configuration, the image originates from a color image camera Bag.1, Bag.2. The OCR unit OCR evaluates an address database Add-DB. The address reader OCR-VCS supplies the address indications Add.

The sorting installation with the address reader OCR-VCS transports the items of mail from the singulator Ver through to the ejecting device AE. If the sorting installation has an address reader, then the ejecting device AE ejects items of mail into one of the many sorting end points Ae.1, Ae.2, . . . , depending on the deciphered indications Add regarding the destination address. For this purpose, the ejecting device AE employs a computer-available sorting plan that assigns a respective sorting end point Ae.1, Ae.2, . . . to every possible destination address.

The sorting installation without an address reader preferably produces, in each sorting end point Ae.1, Ae.2, . . . , a respective stack with upright items of mail that are oriented. “Oriented” means that the franking marks of all the items of mail in a sorting end point Ae.1, Ae.2, . . . all point in the same direction, e.g. all toward the left. It is possible that the franking marks on items of mail in individual sorting end points Ae.1, Ae.2, . . . could not be cancelled because the items of mail were oriented incorrectly upon passing through the sorting installation. In addition, the sorting installation preferably has sorting end points for items of mail that are not machine-processable and for insufficiently franked items of mail or items of mail that have not been franked at all.

In one configuration, the sorting installation sorts the items of mail e.g. depending on a physical parameter or preferably according to whether or not the sorting installation has discovered a valid franking mark on an item of mail.

Each color image camera Bag.1, Bag.2 generates a colored computer-available image (color image) Abb.1, Abb.2 of a respective surface of the item of mail. In the case of a flat item of mail, these are an image Abb.1 of the front side and an image Abb.2 of the rear side of the item of mail. Preferably, each flat item of mail is transported through in an upright fashion and with the longitudinal edges oriented horizontally between the two color image cameras Bag.1, Bag.2. It is possible for a color image camera Bag.1, Bag.2 to generate a plurality of color images of the same surface of the same item of mail, e.g. in order computationally to compose an image of a surface of a large item of mail from a plurality of individual images.

This at least one color image Abb.1, Abb.2 per surface is generated by light in the visible range. In one configuration, a light source illuminates the surface of the item of mail with light in the visible range. The color image Abb.1, Abb.2 shows all objects with which the surface is provided, that is to say shows the entire surface of an item of mail and not just a partial region. The objects on the surface include indications regarding the destination address, indications regarding the sender's address, a franking mark and often a logo and/or an advertizing imprint and an endorsement or a deliverer note. As already mentioned, the address reader OCR-VCS, in one configuration, evaluates such a color image Abb.1, Abb.2 from a color image camera Bag.1, Bag.2 in order to decipher the destination address.

In the exemplary embodiment, each valid franking mark is provided with a luminescent security feature. “Luminescent” is the generic term encompassing “to fluoresce” and “to phosphoresce”. A fluorescent security feature reflects light in a specific waveband only for as long as the security feature is illuminated with the light. A phosphorescent security feature is still luminous for a few milliseconds after the end of such irradiation. This security feature distinguishes a genuine franking mark from a counterfeit, e.g. a genuine stamp from a color copy.

Each security feature detector (“indicia detector”) ID.1, ID.2, ID.3, ID.4 has a light source LQ.1, LQ.2, . . . and at least one recognition unit. Preferably, each security feature detector has a respective recognition unit for a fluorescent security feature and for a phosphorescent security feature.

Each recognition unit has a lens Li.1, Li.2, . . . , a color filter, optionally an optical waveguide (e.g. made of glass fiber), an arrangement having at least one photodiode Ph.1, Ph.2, . . . or having at least one photomultiplier, a security feature data memory Sm-DB.1, Sm-DB.2, . . . , which stores identifications of all security features that are used as part of franking marks, and a decision unit EE.1, EE.2, . . . .

The light source LQ.1, LQ.2, . . . emits light in a specific waveband, e.g. ultraviolet light, infrared light or light in a specific hue, e.g. in a specific blue. The light impinges on the surface of the item of mail. The color filter allows only light in a specific waveband to pass, in order that the security feature becomes better able to be recognized. The photodiode arrangement Ph.1, Ph.2, . . . converts impinging light that has passed through the color filter into electrical signals. These electrical signals are communicated to the decision unit EE.1, EE.2, . . . .

The decision unit EE.1, EE.2, . . . decides whether the light which impinges on the photodiode arrangement Ph.1, Ph.2, . . . and generates an image in specific light originates from a valid security feature. The decision units EE.1, EE.2, . . . cannot necessarily ascertain whether or not this security feature is part of a franking mark and whether or not the franking mark is valid. A valid security feature is a security feature which is used by this transport service provider for the franking of items of mail and is therefore associated with a genuine franking mark.

For the inspection to determine whether or not the item of mail is provided with a valid security feature, the decision unit EE.1, EE.2, . . . evaluates the security feature data memory Sm-DB.1, Sm-DB.2, . . . in order to decide whether an image of a security feature whose identification is stored in the security feature data memory Sm-DB.1, Sm-DB.2, . . . impinges on the photodiode arrangement Ph.1, Ph.2, . . . . It is sufficient for the decision unit EE.1, EE.2, to be able to decide whether or not the generated image contains a predefined security feature, that is to say a security feature whose identification is stored in the security feature data memory Sm-DB.1, Sm-DB.2. It is possible, but not necessary, for the decision unit EE.1, EE.2, . . . to be able to decide whether or even what franking mark is present.

Each security feature detector ID.1, ID.2, ID.3, ID.4 can examine a surface of an item of mail with regard to the presence of a valid security feature. The item of mail is preferably transported in an upright and oriented fashion past the security feature detector ID.1, ID.2, ID.3, ID.4, and the security feature detector ID.1, ID.2, ID.3, ID.4 examines that surface of the item of mail which faces it.

In one configuration, the security feature detector ID.1, ID.2, ID.3, ID.4 can examine the entire surface. In a simpler configuration, the security feature detector ID.1, ID.2, ID.3, ID.4 can examine a specific partial region of the surface (“inspection region”) and yield the result as to whether or not a security feature and therefore a genuine franking mark are situated in the partial region.

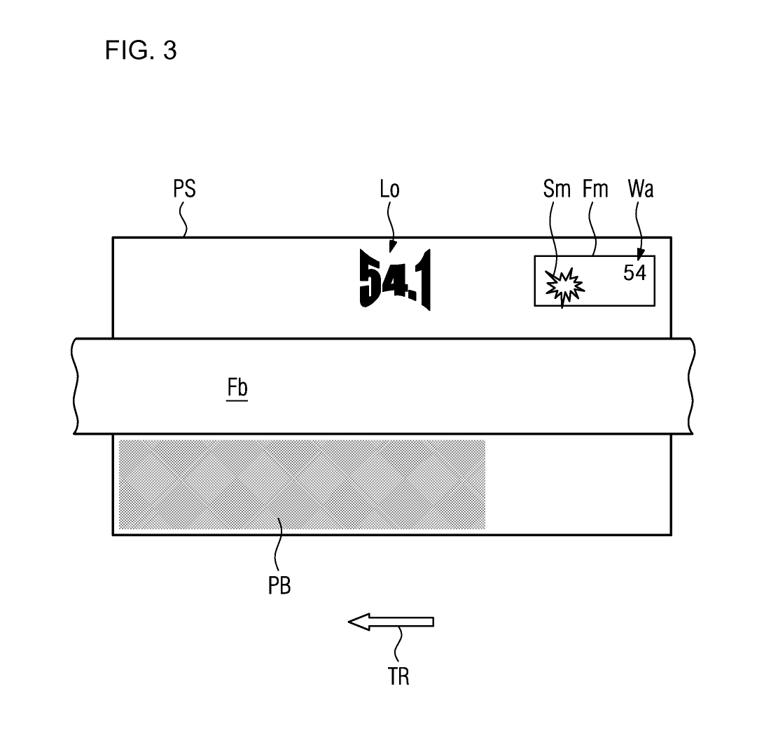

FIG. 3 illustrates an item of mail Ps with a franking mark Fm and an inspection region PB of a security feature detector (not shown). A continuous conveyor belt Fb and a further continuous conveyor belt (not shown) of a pinch belt system transport the items of mail Ps in the transport direction TR. The franking mark Fm is provided with a security feature Sm and a value indication Wa. The item of mail Ps is additionally provided with a logo Lo. A security feature detector ID.1, ID.2, . . . emits light in a direction perpendicular to the plane of the drawing of FIG. 3 onto the surface of the item of mail Ps. The security feature detector ID.1, ID.2, . . . can examine an inspection region PB to determine whether the inspection region PB has a security feature. As long as the item of mail Ps is oriented in the manner shown in FIG. 3, however, the security feature detector cannot discover the security feature Sm in the franking mark Fm.

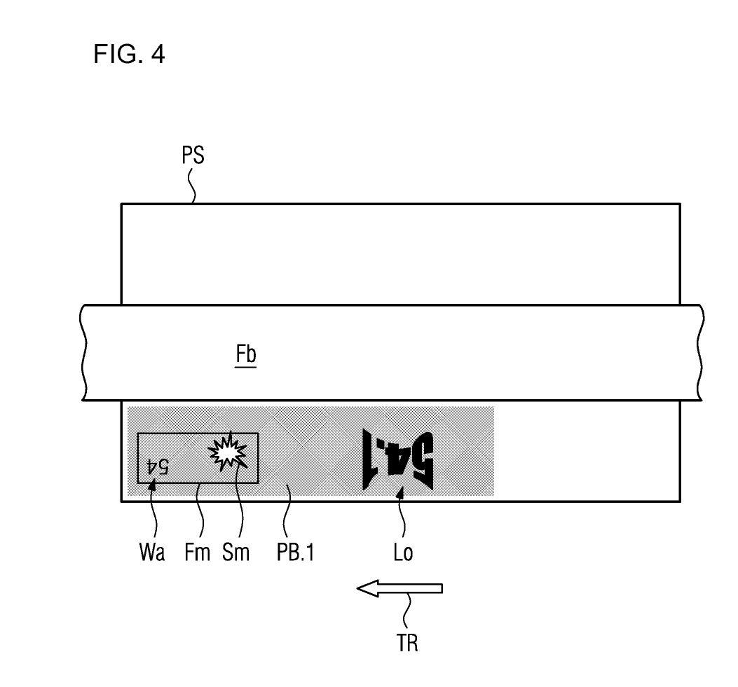

FIG. 4 illustrates the situation from FIG. 3 after the orientation of the item of mail Ps has been changed. An inspection region is now examined anew. However, this inspection region examined during the renewed inspection now occupies a different partial region of the surface of the item of mail Ps and is therefore designated by PB.1 in FIG. 4. The security feature detector can now discover the franking mark Fm with the security feature Sm. The inspection region PB from FIG. 3 and the inspection region PB.1 from FIG. 4 can be associated with different security feature detectors or, alternatively, with the same security feature detector.

In a development of this configuration, the security feature detector ID.1, ID.2, ID.3, ID.4 can additionally supply information about the position of the franking mark or at least of the security feature in the examined partial region. The partial region (inspection region) is e.g. a strip having a specific length and height which begins in the leading edge of the item of mail and lies on one longitudinal edge or runs parallel to the lower edge of the item of mail transported in an upright fashion. The height of the strip is limited by the dimensions of the lens Li.1, Li.2, Li.3, Li.4, the color filter and/or the photodiode arrangement Ph.1, Ph.2, Ph.3, Ph.4. Moreover, in one configuration, the item of mail is transported by means of a continuous conveyor belt which is situated between the security feature detector ID.1, ID.2, ID.3, ID.4 and the item of mail Ps and upwardly limits the height of the strip. This limitation is illustrated in FIG. 3.

In one configuration, franking marks with different security features are used. Each security feature detector ID.1, ID.2, ID.3, ID.4 can additionally decide about what type of security feature of a franking mark is involved. The security feature detector ID.1, ID.2, ID.3, ID.4 cannot necessarily recognize what franking mark is situated in the partial region.

The sorting installation has at least one security feature detector ID.1, ID.2, ID.3, ID.4 because only a security feature detector can recognize a security feature, but not the color image evaluation unit Fb-AE, which cannot distinguish a genuine franking mark with security features from a counterfeit franking mark if the counterfeit is good enough.

Each security feature detector ID.1, ID.2, ID.3, ID.4 supplies its respective result to the detector evaluation unit De-AE. The security feature detectors ID.1, ID.2, ID.3, ID.4 examine a respective surface of the item of mail, to be precise—in one configuration—only one partial region. Moreover, their results may be beset by uncertainty or even incorrect in individual cases. The detector evaluation unit De-AE produces an overall inspection result Prüf-ges by evaluating the results of the security feature detectors ID.1, ID.2, ID.3, ID.4 and the inspection result Prüf-Abb from the color image evaluation unit Fb-AE. The overall inspection result Prüf-ges is communicated to the control unit SE.

Colored images of valid franking marks are stored in the franking mark database Fm-DB. “Valid” means: of franking marks which are accepted by a carrier of articles in a specific period of time. For differentiation purposes, reference is made to a “colored image of a surface of an item of mail” and “image of a franking mark”. A valid franking mark can be a genuine or a counterfeit franking mark. In the images stored in the franking database Fm-DB, the security features cannot be recognized because the images show the franking marks in visible, preferably white light and the image of a genuine franking mark therefore cannot be differentiated from the image of a “good” counterfeit, e.g. a good color copy.

Preferably, the franking mark database Fm-DB has a respective data record for each valid franking mark taken into account. The data record contains an internal identifier and also at least one computer-available colored image which shows the franking mark in visible light. The images in the franking mark database Fm-DB show the franking marks in the case of illumination in white or otherwise visible light. The security features cannot be recognized in this white light.

By virtue of the invention, it is not necessary to fill the franking mark database Fm-DB with images of valid franking marks in a preceding training phase. Such a preceding training phase requires time and has to be carried out anew whenever valid franking marks appear anew on the market, e.g. because a mail service provider issues new stamps. By virtue of the invention, rather, the updating unit Akt in the course of operation automatically supplements this franking mark database Fm-DB with further images of valid franking marks, which will be described in detail below.

The color image evaluation unit Fb-AE has read access to the franking mark database Fm-DB. The color image evaluation unit Fb-AE evaluates a color image Abb.1, Abb.2 from a color image camera Bag.1, Bag.2 to determine whether the color image shows a franking mark which is stored in the franking mark database Fm-DB and is therefore treated as a valid franking mark. If the franking mark is valid, then the color image evaluation unit Fb-AE furthermore determines which franking mark from the franking mark database Fm-DB the item of mail carries. Since the color image evaluation unit Fb-AE has to yield its result within a predefined time period of typically less than one second, the franking mark database Fm-DB is a local component of the sorting installation. The predefined time requirement could not be complied with if the color image evaluation unit Fb-AE had to access a spatially remote database.

The color image evaluation unit Fb-AE communicates its inspection result Prüf-Abb to the control unit SE. In one embodiment, the inspection result Prüf-Abb comprises an internal identifier of the franking mark recognized as valid. This internal identifier is associated with a data record for the franking mark in the franking mark database Fm-DB. By means of the internal identifier, it is possible automatically to determine what value indication the franking mark carries, because this information is stored as part of the data record.

The mode of operation of the sorting installation is described below.

The first transport unit transports the upright items of mail that are spaced apart from one another as a stream of articles from the singulator Ver to the turning device WE. The first transport device transports each item of mail on the path from the singulator Ver to the turning device WE through between the two color image cameras Bag.1, Bag.2 and in one configuration through between two security feature detectors ID.1, ID.2.

In the exemplary embodiment, the first transport device comprises a so-called pinch belt system. An item of mail to be processed is clamped, in an upright fashion, temporarily in between two continuous conveyor belts that are guided around a plurality of rollers or shafts in each case. The axes of the rollers or shafts are all perpendicular. The two continuous conveyor belts rotate in the same direction and at the same speed and thereby transport an upright item of mail.

The two color image cameras Bag.1, Bag.2 generate a respective colored image Abb.1, Abb.2 of a surface of the flat item of mail. After the item of mail has been transported through between the color image cameras Bag.1, Bag.2, a respective color image Abb.1, Abb.2 of both surfaces, that is to say of the front side and of the rear side, of the item of mail is present. For evaluating the two color images, the color image evaluation unit Fb-AE decides which is the front side and which is the rear side of the item of mail. For this purpose, the color image evaluation unit Fb-AE searches for an image of destination address indications and/or franking marks in the color image Abb.1, Abb.2 of a surface of the item of mail.

It is possible that a franking mark on the item of mail has not yet been stored in the franking mark database Fm-DB. In this case, the color image evaluation unit Fb-AE cannot recognize this franking mark and identify it as a valid franking mark. This is because the color image evaluation unit Fb-AE then cannot differentiate a valid franking mark with sufficient certainty from a logo, an advertising imprint, a decorative sticker, a delivery note or a similar object with which an item of mail can be provided.

The two security feature detectors ID.1, ID.2 upstream of the turning device WE analyze a respective partial region of a surface, that is to say overall a partial region of the front side and a partial region of the rear side of the item of mail.

In one configuration, each security feature detector ID.1, ID.2 analyzes a partial region, e.g. a strip, of that surface of the item of mail which faces the security feature detector ID.1, ID.2. The partial region lies below or else above the facing continuous conveyor belt.

In another configuration, each security feature detector ID.1, ID.2 can analyze the entire surface of the item of mail which faces the detector.

In a further configuration, not only two, but even four security feature detectors ID.1, ID.2, ID.3, ID.4 are used, which are all situated upstream of the turning device WE. Two security feature detectors analyze a partial region of a surface below a facing continuous conveyor belt of the pinch belt system. The other two security feature detectors analyze a partial region of the surface above the facing continuous conveyor belt.

The printer Dru has a print head Dru-Ko and a printing gate Dru-Ku. The item of mail is transported through between the print head Dru-Ko and the printing gate Dru-Ku, to be precise by the second transport device, which likewise contains a pinch belt system. The item of mail therefore has to be oriented such that the surface with the franking mark (the front side) faces the print head Dru-Ko and not the printing gate Dru-Ku. This is because the print head Dru-Ko is intended, after all, to apply the imprint to the surface in such a way that the franking mark on the surface is cancelled. Furthermore, the franking mark has to be oriented relative to the print head Dru-Ko in such a way that—depending on the arrangement of the print head Dru-Ko—the franking mark is situated either always above or always below the continuous conveyor belt.

Therefore, the sorting installation of the exemplary embodiment has a turning device WE. The turning device WE turns a flat item of mail about the longitudinal axis of the item of mail as necessary. “As necessary” means:

a) when a security feature detector ID.1, ID.2 upstream of the turning device WE has discovered a franking mark above a continuous conveyor belt, but the print head Dru-Ko prints only below the continuous conveyor belt,
b) when no security feature detector ID.1, ID.2 at all upstream of the turning device WE has discovered a franking mark and the security feature detectors ID.1, ID.2, ID.3, ID.4 overall can analyze only a lower or only an upper partial region, or
c) when no security feature detector at all is situated upstream of the turning device WE and the color image evaluation unit Fb-AE has recognized that the franking mark is positioned incorrectly with respect to the print head Dru-Ko.

The turning device WE therefore has a turning path Wst, a bypass path Wst-By around the turning path Wst, a diverter W-Wst and any combining point Z-Wst.

The turning path Wst and the bypass path Wst-By branch off from the diverter W-Wst. The turning path Wst and the bypass path Wst-By come together again in the combining point Z-Wst.

The turning path Wst can rotate an item of mail about its longitudinal axis, that is to say about a horizontal axis of rotation. Optionally, the sorting installation additionally has a rotating device, which can rotate an item of mail about its vertical axis, that is to say about a perpendicular axis of rotation. The rotating device DE contains at least one head station Kbf, a bypass path Kbf-By around the head station Kbf, a diverter W-Kbf, which directs an item of mail optionally into the head station Kbf or into the bypass path Kbf-By, and a combining point Z-Kbf.

The control unit SE drives the diverters W-Wst and W-Kbf.

The second transport device transports the items of mail from the turning device WE in one configuration through between two further security feature detectors ID.3, ID.4, in another configuration past a security feature detector, through between the print head Dru-Ko and the printing gate Dru-Ku, and to the ejecting device AE.

In each configuration, at least one security feature detector is situated downstream of the turning device WE. The apparatus in accordance with FIG. 1 has two franking detectors ID.1, ID.2 upstream of the turning device WE and two further security feature detectors ID.3, ID.4 downstream of the turning device WE.

Once again a configuration is possible in which each security feature detector ID.3, ID.4 downstream of the turning device WE can analyze a partial region above the continuous conveyor belt or below the continuous conveyor belt. In another configuration, each security feature detector ID.3, ID.4 downstream of the turning device can analyze the entire surface. In a third configuration, four security feature detectors downstream of the turning device WE are once again used.

In one configuration, the sorting installation has a security feature detector ID.1, the turning device WE and additionally a return path. If the security feature detector ID.1 has not discovered a security feature, then the turning device WE turns the item of mail, preferably about its longitudinal axis. The return path transports the turned item of mail back upstream. The first transport device transports the turned item of mail past the same security feature detector ID.1 again. The security feature detector ID.1 searches anew for a security feature in a predefined inspection region. The inspection region PB.1 during the renewed inspection differs from the inspection region PB during the first inspection. This configuration makes it possible to manage with a single security feature detector ID.1 and nevertheless to examine successively different inspection regions on the surface of an item of mail. These two inspection regions PB.1, PB are illustrated in FIG. 3 and FIG. 4.

The control unit SE receives signals from light barriers which are situated within the sorting installation and are interrupted by an upright item of mail. As a result, the control unit SE “knows” at any point in time where which item of mail is situated in the sorting installation, and assigns the signals from the cameras Bag.1, Bag.2 and the security feature detectors ID.1, ID.2 to the respectively correct item of mail. The signals from these sensors are communicated to the detector evaluation unit.

Signals from the security feature detectors ID.1, ID.2, . . . and, in the exemplary embodiment, the inspection result Prüf-Abb from the color image evaluation unit Fb-AE are communicated to the detector evaluation unit De-AE. The inspection result Prüf-Abb from the color image evaluation unit Fb-AE is based on signals from the cameras Bag.1, Bag.2.

Each signal from a color image camera Bag.1, Bag.2 contains either an identification of a specific franking mark from the franking mark database Fm-DB and also an identification of the position of the franking mark on the surface of the item of mail, or the information that no valid franking mark from the franking mark database Fm-DB has been recognized on the item of mail.

Each signal from a security feature detector ID.1, ID.2, . . . contains either the information that a security feature Sm for a franking mark Fm has been discovered in the analyzed inspection region PB (partial region or entire surface) and optionally the position of the security feature Sm on the surface, or the information that no predefined security feature has been discovered in the inspection region PB.

Depending on the configuration, the detector evaluation unit De-AE takes at least one of the following decisions for an item of mail:

a) the item of mail is provided with a valid and genuine franking mark,
b) the item of mail is provided with a valid franking mark. Whether this franking mark is genuine cannot be reliably decided, and c) the item of mail is provided with a valid security feature. Whether this valid security feature is associated with a franking mark cannot be reliably decided.
For this decision, the detector evaluation unit De-AE evaluates first the inspection results which relate to the security feature and originate from the security feature detectors ID.1, ID.2, . . . , and second the inspection results which relate to the franking mark and originate from the color image evaluation unit Fb-AE.

One possible result is that all the following conditions are met: a security feature detector ID.1, ID.2 upstream of the turning device WE has discovered a franking mark, a security feature detector ID.3, ID.4 downstream of the turning device WE has likewise discovered a franking mark, both franking marks are valid, and the positions ascertained are consistent with one another, that is to say originate from the same element on the surface of the item of mail.

This item of mail is then provided with a valid and genuine franking mark.

Another possible result is: although a plurality of security feature detectors ID.1, ID.2, . . . have each discovered a franking mark, the positions ascertained are not consistent with one another. A reliable statement is then not possible.

Another possible result is: only one security feature detector ID.1, ID.2, . . . has discovered a franking mark. Depending on the configuration of the detector evaluation unit De-AE and the configuration of the security feature detectors ID.1, ID.2, . . . , either it is nevertheless decided that a genuine franking mark is present, or it is decided that a sufficiently reliable statement is not possible. In the configuration in accordance with FIG. 1 with two franking mark detectors ID.1, ID.2 upstream of the turning device WE and two security feature detectors ID.3, ID.4 downstream of the turning device WE, in general only one security feature detector in each case will discover a security feature because the inspection region of each security feature detector is correspondingly narrow and short.

Another possible result is: no security feature detector ID.1, ID.2, . . . has recognized a franking mark. In that case, either the item of mail has no franking mark at all, or the item of mail is currently oriented such that the security feature detectors ID.1, ID.2, . . . used cannot discover the franking mark as long as the item of mail is situated in this orientation. This result is possible, in particular, when the sorting installation overall has only one security feature detector.

If the detector evaluation unit De-AE, on the basis of the signals from the security feature detectors ID.1, ID.2, . . . , has recognized that an item of mail has on a surface a valid security feature in a specific partial region of the surface, then the now described steps are implemented.

An inspection is carried out to determine whether the color image evaluation unit Fb-AE has discovered a valid franking mark in the partial region and the valid franking mark has a valid security feature. If the item of mail indeed carries a valid franking mark, that is to say a franking mark whose image corresponds to a stored image, but the item of mail carries a valid security feature, then either the franking mark is counterfeit, or the security feature detectors ID.1, ID.2, . . . have not recognized the valid security feature present. In both cases, the item of mail is preferably ejected into a specific sorting outlet Rej (“reject outlet”). The control unit SE drives a diverter W-Rej such that the diverter W-Rej diverts the item of mail into a path to the sorting outlet Reg.

If the item of mail indeed carries a franking mark with a valid security feature, but the franking mark cannot be recognized as valid, then what happens with this item of mail is dependent on the configuration of the detector evaluation unit DE-AE. In one configuration, the item of mail is nevertheless sorted again, that is to say transported to the ejecting device AE. In another configuration, the item of mail is diverted into the sorting outlet Rej. In a third configuration, an attempt is made to decipher a value indication in the image of the franking mark. If the value indication lies above a predefined limit, then the item of mail is ejected into the sorting outlet Rej, otherwise it is transported further to the ejecting device AE.

If the color image evaluation unit of Fb-AE has actually discovered a valid franking mark from the franking mark database Fm-DB at this position, then the item of mail has a valid and genuine franking mark.

If the color image evaluation unit Fb-AE has not recognized a franking mark at this position, then the color image evaluation unit Fb-AE identifies an object in the colored image Abb.1, Abb.2 of the surface in this partial region as a franking mark. For this purpose, the color image evaluation unit Fb-AE uses the information about the partial region in which the at least one security feature detector ID.1, ID.2, . . . discovered a genuine franking mark, and optionally information about the position Pos of the genuine franking mark in the partial region. To put it more precisely: the security feature detector ID.1, ID.2 discovers and communicates the position Pos of a security feature in the analyzed partial region.

The color image evaluation unit Fb-AE evaluates a computer-executable description which classifies an image of a graphical object in the image of the surface either as an image of a franking mark, and supplies the contour line thereof, or as some other graphical object, e.g. a logo or a decorative sticker. The color image evaluation unit FB-AE identifies e.g. the contour of a stamp, which is generally rectangular and in rare cases triangular and has either perforations or regularly arranged cutouts around the contour line. A stamp has either perforations or, if the stamp originates from an automatic machine, semicircular cutouts. The color image evaluation unit Fb-AE generates a colored computer-available image Bi of the franking mark. The updating unit Akt automatically supplements the franking mark database Fm-DB by the image Bi. This is because the image Bi shows a franking mark provided with a valid security feature. A predefined criterion is applied in order to decide whether the franking mark is actually a valid franking mark. As soon as the criterion is satisfied, the image Bi is stored as an image of a valid franking mark in the franking mark database Fm-DB.

The updating unit Akt preferably generates a new data record in the franking mark database Fm-DB.

In one configuration, the image Bi of an additional franking mark is already accommodated in the franking mark database Fm-DB when the franking mark has been discovered for the first time. In this case, therefore the criterion is already satisfied upon the first occurrence of a new franking mark.

In another configuration, a candidate data memory Kand-DB is additionally used. An image Bi of an additional franking mark is stored in the candidate data memory Kand-DB as soon as the franking mark has been discovered for the first time. The number of times the franking mark is subsequently discovered anew is counted. If this counted number exceeds a predefined amount, then a data record for this additional franking mark is created in the franking mark database Fm-DB, and the entry in the candidate database Kand-DB is erased. The data record then contains an image Bi of the multiply discovered franking mark. The criterion is therefore satisfied if the counted number of occurrence exceeds a predefined limit. Preferably, the data record for the candidate (for the image Bi of a franking mark) in the candidate database Kand-DB contains a counter, which is incremented by one upon each new occurrence of the franking mark.

One modification additionally calculates a measure of certainty for the fact that the image Bi is actually an image of a franking mark which had hitherto not been taken into account in the franking mark database Fm-DB. If the measure of certainty exceeds a predefined limit, then a data record with this image Bi is stored in the franking mark database Fm-DB. Otherwise, an entry with the image Bi and each measure of certainty is generated in the candidate database. When the franking mark is recognized anew, a measure of certainty is calculated anew and aggregated with the stored measure of certainty to form an overall measure of certainty. This is repeated, and the respective overall measure of certainty is updated and stored. If the overall measure of certainty exceeds a predefined limit, then a new data record for the franking mark is stored in the franking mark database Fm-DB, and the entry in the candidate database Kand-DB is erased.

In one configuration, a franking mark has a fluorescent security feature or, in the case of illumination with light having a specific wavelength, an element which unambiguously identifies the franking mark, or can be identified unambiguously in its entirety in the case of light with the specific wavelength. By contrast, the franking mark cannot be unambiguously recognized as a valid franking mark in the case of illumination with white light, such that the color images from the color image cameras Bag.1, Bag.2 alone do not suffice to recognize a valid franking mark from other objects on the surface of an item of mail. It is possible that the franking mark database Fm-DB does not currently contain all valid franking marks.

In one configuration, a security feature detector ID.1, ID.2, . . . can differentiate different classes of franking marks. These different classes are predefined, e.g. on the basis of different types of or differently shaped fluorescent security features. The information regarding the class to which a discovered franking mark belongs is likewise communicated to the detector evaluation unit De-AE. This information is additionally stored in the franking mark database Fm-DB and used for later adjustments.

As already set out, the franking mark database Fm-DB is a local component of the sorting installation. In one embodiment, identical sorting installations each having a local franking mark database Fm-DB are used at different locations.

In one configuration, the updating unit Akt according to the solution together with a franking mark database is used in one of the identical sorting installations and functions as a master database. The data records from this franking mark database Fm-DB which functions as a master database are repeatedly copied and communicated to the other sorting installations and stored there in the respective local franking mark database Fm-DB. This configuration ensures that the franking mark databases of the sorting installations correspond. In one configuration, the candidate database Kand-DB is designed as a central database, and a plurality of sorting installations communicate their results to the central database.

In another configuration, each sorting installation has its own updating unit Akt which updates the local franking mark database Fm-DB. This configuration obviates the otherwise necessary step of repeatedly producing and distributing copies of the master databases.

In one configuration, the color image evaluation unit Fb-AE additionally searches for a value indication in the image Bi of the object which has been identified as an image of a franking mark. By way of example, a stamp has a sequence of numbers used as a value indication in a specific currency unit. The data record in the franking mark database Fm-DB for this franking mark is supplemented by the value indication.

In one embodiment, a processor checks at least once whether the franking mark database Fm-DB actually only contains images of valid franking marks. Preferably, the processor checks all images that have been added to the franking mark database Fm-DB after a specific point in time, e.g. after the last check. Preferably, each data record for a franking mark contains a timestamp, namely the date on which this data record was created, or the date on which this data record was checked the last time. The added images of franking marks are displayed successively on a screen device. The value indication determined is additionally displayed. The processor inputs whether or not the image Bi actually shows a franking mark. A data record whose image does not show a valid franking mark is removed from the franking mark database Fm-DB. As necessary, the processor corrects the automatically determined value indication. In one embodiment, the processor additionally corrects the contour line of a franking mark if the contour line has been determined incorrectly and the image shows, in addition to the franking mark, further elements, e.g. parts of a postmark or some other imprint on the item of mail.

1. A method for determining if a region of a surface of an article is provided with a valuable document, and the valuable document being a genuine valuable document has a predefined security feature, which method comprises the steps of:
generating a computer-available image of a surface region of the article;
carrying out an inspection to determine if the computer-available image contains an object image which has a property corresponding to a computer-available image of a valuable document stored in a valuable document data memory storing images of valuable documents;
if the computer-available image contains the object image corresponding to the computer-available image of the valuable document, determining that the object image is a valuable document and the surface region is provided with the valuable document;
if the computer-available image does not contain the object image corresponding to the computer-available image in the valuable document data memory, performing the further steps of:
carrying out an inspection to determine if a predefined inspection region has one of the predefined security features, and the inspection region lies in the surface region;
if the predefined security feature has been determined, the valuable document is sought in the predefined inspection region using the computer-available image of the surface region; and
if the valuable document is found in the predefined inspection region, generating an image of the valuable document using an image of the surface region, and when predefined criterion are additionally satisfied, storing the image in the valuable document data memory, and determining that a surface in the predefined inspection region is provided with the valuable document.

2. The method according to claim 1, which further comprises:
transporting each article to be inspected in a transport direction during an inspection;
if no predefined security feature has been determined in the inspection region during the inspection, changing an orientation of the article as seen in the transport direction; and
carrying out an inspection anew to determine if the predefined inspection region in the surface region has one of the predefined security features.

3. The method according to claim 2, which further comprises:
providing a security feature detector to implement the inspection in the predefined inspection region; and
if the security feature detector has not discovered any predefined security feature in the predefined inspection region, carrying out, via the security feature detector, after an orientation change, the inspection anew to determine whether the predefined security feature is present in an inspection region produced by the orientation change.

4. The method according to claim 1, wherein when one of the predefined security features has been determined in the predefined inspection region during the inspection, performing the steps of:
additionally determining a position of the predefined security feature in the predefined inspection region; and
using the position of the predefined security feature determined for a search for the valuable document in the computer-available image.

5. The method according to claim 1, which further comprises:
effecting automatically a counting of how many articles are provided with a non-corresponding valuable document; and
deciding that the predefined criterion is satisfied if as number of the articles reaches or exceeds a predefined limit.

6. The method according to claim 1, wherein if the object image does not correspond to the object image stored in the valuable document data memory, performing the further steps of:
carrying out an inspection to determine if the object image corresponds to a computer-available image of a further valuable document stored in a further data memory;
if no corresponding object image is stored in the further data memory, generating and storing the image of the valuable document in the further data memory;
if the corresponding object image is stored in the further data memory, carrying out an inspection to determine if the predefined criterion is satisfied; and
if the predefined criterion is satisfied, storing the corresponding object image stored in the further data memory in the valuable document data memory.

7. An inspection apparatus for automatically inspecting if a region of a surface of an article is provided with a valuable document, wherein the valuable document being a genuine valuable document has a predefined security feature, the inspection apparatus comprising:
an image recording device for generating a computer-available image of the region of the surface of the article;
a valuable document data memory for storing computer-available images of valuable documents;
an image evaluation unit configured to inspect if the computer-available image from said image recording device contains an object image corresponding to an image stored in said valuable document data memory, said image evaluation unit further searching for the valuable document in the computer-available image of the region of the surface, and generating a further computer-available image of the valuable document using the computer-available image from said image recording device;
a security feature data memory for storing a respective identification of at least one predefined security feature;
a security feature detector configured to inspect, using said security feature data memory, if a predefined inspection region of the region of the surface of the article has the predefined security feature;
the inspection apparatus programmed to implement the following steps, for each said article:
generate, via said image recording device, the computer-available image of the region of the surface of the article;
inspect, via said image evaluation unit, if the computer-available image contains an object image corresponding to an image in said valuable document data memory;
if the image contains the object image corresponding to the image in said valuable document data memory, determine that the article is a valuable document and the region of the surface is provided with the valuable document;
if the computer-available image does not contain the object image corresponding to the image in said valuable document data memory, implement the following steps:
inspecting, via said security feature detector, if the region of the surface of the article in the predefined inspection region has one of the predefined security features;
if said security feature detector has determined such a security feature, said image evaluation unit searches for the valuable document in the predefined inspection region using the computer-available image of the region of the surface; and
if said image evaluation unit has found the valuable document, said image evaluation unit generates the further computer-available image of the valuable document using the computer-available image of the region of the surface, and when a predefined criterion is satisfied, the apparatus stores said further computer-available image in said valuable document data memory and decides that the surface in the predefined inspection region is provided with the valuable document.

8. The apparatus according to claim 7, further comprising:
a further security feature detector;
an orientation change device;
the apparatus configured to transport the article to be inspected in a transport direction during the inspection;
said orientation change device configured to change an orientation of the article to be inspected, as seen in the transport direction; and
the apparatus configured to the effect that when said security feature detector has not found a security feature in the predefined inspection region of the article, said orientation change device changes the orientation of the article, and said further security feature detector likewise inspects if a predefined inspection region in the surface region has one of the predefined security features.
